(19) United States
(12) Patent Application Publication
(10) Pub. No.: US 2017/0109414 A1
(43) Pub. Date: Apr. 20, 2017

(54) GRAPHICAL USER INTERFACES FOR PORTFOLIO MANAGEMENT AND DISTRIBUTION SYSTEM

(71) Applicant: LifeStream Digital Innovations LLC, Rye, NY (US)

(72) Inventor: ANNE SULLIVAN, Rye, NY (US)

(21) Appl. No.: 15/297,810

(22) Filed: Oct. 19, 2016

Related U.S. Application Data
(60) Provisional application No. 62/243,579, filed on Oct. 19, 2015.

(51) Int. Cl. G06F 17/30; G06F 3/0482

(52) U.S. Cl. CPC G06F 17/30554; G06F 17/30424; G06F 17/3053; G06F 3/0482; H04L 67/06

(57) ABSTRACT

An individual user graphical user interface (GUI) that provides functionality for an individual user to upload content items, identify a category for each content item (each category identifying to an attribute of the individual user), create a portfolio by selecting content items, and share the portfolio such that the portfolio may be remotely viewed via a communications network.

### CROSS REFERENCE TO RELATED APPLICATIONS

This application claims priority to U.S. Provisional Patent Application No. 62/243,579, filed Oct. 19, 2015, the entire contents of which is hereby incorporated by reference.

### BACKGROUND

When applying to colleges and universities, gifted and talented programs, private and independent schools, applicants will often share documents, images, video and audio files with the admissions departments of those schools that show that the applicants possess certain attributes or skills. Similarly, job applicants will often share a portfolio of their work. However, the relevant items for applications (e.g., documents, video, images, audio) are also not always easily accessible because items are not always being maintained on an ongoing basis in digital format. Instead, the user may be maintaining them in disparate places like a closet, on a computer, separate hard drive, or on a shelf. For items not digitized by the time the applicant needs to put information together for their application, the individual will need to locate each relevant item, and then put each item into the appropriate respective digital format to send with their application.

Some applicants will use a commercial file sharing service such as Dropbox or Google drive. Others create their own website with links to documents, embedded videos, etc. Prior art methods, however, have a number of drawbacks. Relevant items are often overlooked/forgotten or misplaced over time so the user is not able to include all relevant information examples with their application. Additionally, if different applicants use different methods for sharing content, it makes it difficult for the people trying to evaluate those applicants to keep track of where the content for each applicant can be found. It's also difficult for evaluators to identify attributes (e.g., academics, leadership, community service, proficiency in sports, performing arts, visual arts, etc.) and determine which applicants possess those attributes.

Accordingly, there is a need for an improved system for uploading and maintaining digital information and creating and distributing portfolios.

### SUMMARY

In order to overcome these and other drawbacks of the prior art, an individual user graphical user interface (GUI) is disclosed that provides functionality for an individual user to upload and maintain content items, identify a category for each content item (each category identifying to an attribute of the individual user), create a portfolio by selecting content items, and share the portfolio such that the portfolio may be viewed remotely (for example, by an institutional user) via a communications network.

Notably, the individual user GUI may include a predetermined list of categories (each identifying an attribute) and provide functionality to identify a category for each content item only by selecting categories from the predetermined list. By ensuring that all individual users use the same nomenclature to refer to the same attributes, the individual user GUI allows an institutional user to more accurately compare individual users and determine which have shared content as evidence that they possess each attribute.

Additionally, by providing an easy-to-use interface for creating, sharing, and managing portfolios, the individual user GUI allows individual users to quickly and easily highlight their accomplishments and allows institutional users to easily and accurately search for, find, learn about, and compare individual users. The system may also provide functionality for the institutional user to communicate with the individual user (for example, by inviting them to apply for a position at the institutional user's institution).

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments, wherein:

FIG. 1 is a block diagram illustrating an architecture of a portfolio management and distribution system according to an exemplary embodiment of the present invention;

FIG. 2 is a block diagram illustrating the portfolio management and distribution system according to an exemplary embodiment of the present invention;

FIG. 3 is a flowchart illustrating a process for individual user to create and share portfolios (for example, with institutional users) and a process for institutional users to search those portfolios according to exemplary embodiments of the present invention;

FIGS. 4-12 are drawings illustrating views of an individual user graphical user interface (GUI) that provides functionality for individual users to digitally store examples of their best work, awards, etc., as well as create, manage, and share portfolios according to exemplary embodiments of the present invention.

FIGS. 13-14 are drawings illustrating views of an institutional user GUI that provides functionality for institutional users to search for and view portfolios shared by individual users according to exemplary embodiments of the present invention.

### DETAILED DESCRIPTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

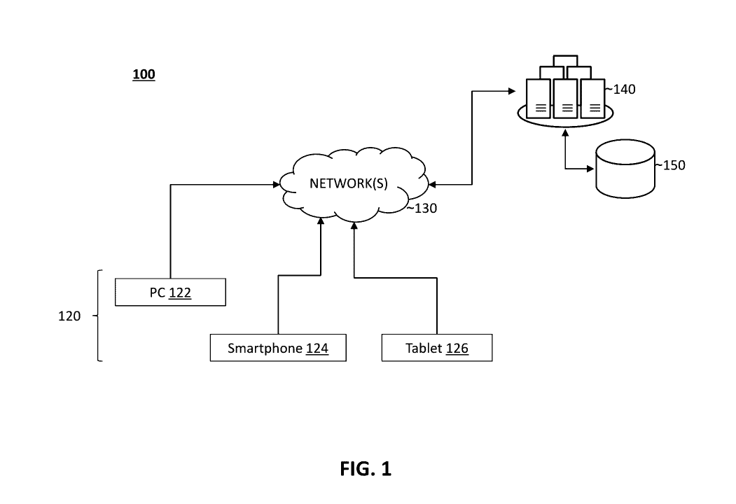

FIG. 1 is a diagram illustrating an architecture 100 of a portfolio management and distribution system according to an exemplary embodiment of the present invention. As shown in FIG. 1, the architecture 100 includes client devices 120 that communicate with one or more servers 140 and one or more storage devices 150 via one or more communications networks 130. The client devices 120 may include for example, personal computers 122, smartphones 124, and tablets 126.

The client devices 120 may include any suitable computing device that communicates with the one or more servers 140 via one or more communications networks 130 and executes instructions to perform the functions described herein. The client devices 120 may include internal storage and one or more computer processors. For example, a client device 120 may communicate with the one or more servers 140 via the internet using a web browser.

The communications network(s) 130 may include one or more short- or long-range data connections that enable the one or more servers 140 to receive and store information output by the client devices 120. The communications network(s) 130 may include one or more local area networks and/or wide area networks (e.g., the internet). The communications network(s) 130 may include wired and/or wireless data connections.

The one or more servers 140 may include any suitable computing device that communicates with the client devices 120 via one or more communications networks 130 and executes instructions to perform the functions described herein. The one or more servers 140 may include internal storage and one or more computer processors. The one or more servers 140 may be remote (i.e., cloud-based) server(s) or may be located at an institution (e.g., an educational institution, businesses, employment agencies, etc. as discussed below).

The one or more storage devices 150 may also include a non-transitory computer readable storage medium, such as a hard disk, solid-state memory, etc. The one or more storage devices 150 may be internal to the one or more servers 140, external to but co-located with the one or more servers 140 (and may communicate with the one or more servers 140 via a local area network), and/or remotely located from the one or more servers 140 (and may communicate with the one or more servers 140 via a wide area network such as the internet). The one or more storage devices 150 may be remote (i.e., cloud-based) storage devices or may be located at an institution (e.g., an educational institution, businesses, employment agencies, etc. as discussed below).

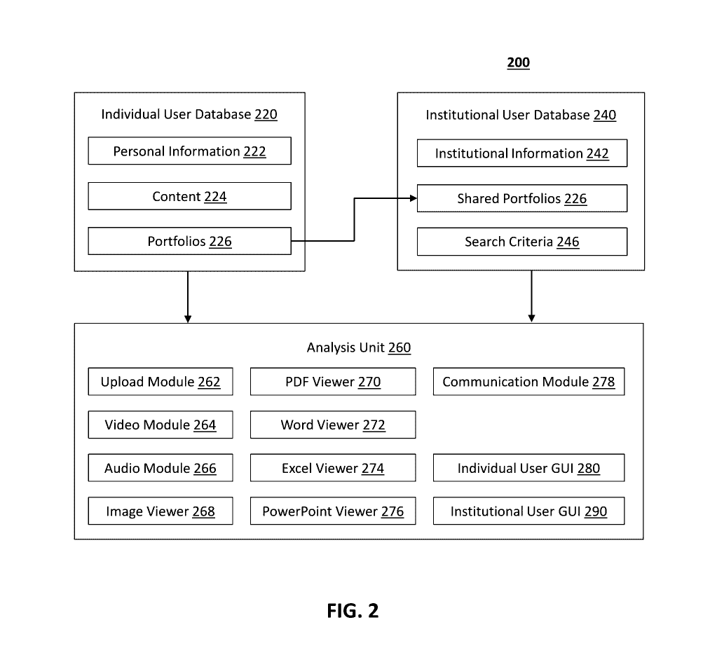

FIG. 2 is a block diagram illustrating the portfolio management and distribution system 200 according to an exemplary embodiment of the present invention.

As shown in FIG. 2, the system 200 includes an individual user database 220 and a processing unit 260. The system 200 may also include an institutional user database 240.

The individual user database 220 and the institutional user database 240 may be any organized collection of information, whether stored on a single tangible device or multiple tangible devices. The individual user database 220 and the institutional user database 240 may be stored, for example, in one or more of the storage devices 150. The individual user database 220 and/or the institutional user database 240 may be remote (i.e., cloud-based) database(s) or may be located at an institution (e.g., an educational institution, businesses, employment agencies, etc. as discussed below).

The individual user database 220 stores information received from individuals (referred to herein as “individuals” or “individual users”) input or uploaded via one of the client devices 120, such as personal information 222, content 224, and portfolios 226. The institutional user database 240 stores information received from institutional users (employees of institutions such as educational institutions, businesses, employment agencies, etc.), including institutional information 242, portfolios 226 shared by individuals with those institutions, and search criteria 246. (FIG. 2 illustrates just one embodiment of the system 200. As one of ordinary skill in the art would recognize, the individual user database 220 and the institutional user database 240 may be combined in a single database. Also, the portfolios 226 that are shared with a particularly institution need not be transferred or copied and stored in the institutional user database 240. Instead, the system may simply keep records of which of the portfolios 226 are shared with each institution.)

The processing unit 260 may include any suitable computing device and/or computer executable software instructions that perform the functions described herein. The processing unit 260 may be realized by hardware elements, such as one or more processors used by the one or more servers 140, and/or software instructions accessible to and executed by the one or more servers 140.

The processing unit 260 includes an individual user graphical user interface (GUI) 280 that enables individual users to input information to and view information from the one or more servers 140 (e.g., via a web browser). Additionally, the processing unit 260 includes an institutional user graphical user interface (GUI) 290 that enables institutional users to input information to and view information from the one or more servers 140 (e.g., via a web browser).

In order to provide the functionality described below, the processing unit 260 may include software modules, including an upload module 262 that provides functionality individual users to upload media (such as video, audio, images, PDFs, Word documents, Excel spreadsheets, PowerPoint presentations, etc.), a video module 264 that provides functionality for users to view videos uploaded via the system 200, an audio module 266 that provides functionality for users to listen to audio files uploaded via the system 200, an image viewer 268 that provides functionality for users to view images uploaded via the system 200, a PDF viewer 270 that provides functionality for users to view PDF files uploaded via the system 200, a Word viewer 272 that provides functionality for users to view Word documents uploaded via the system 200, an Excel viewer 274 that provides functionality for users to view Excel spreadsheets uploaded via the system 200, a PowerPoint viewer 276 that provides functionality for users to view Word documents uploaded via the system 200. Alternatively, users may view media (e.g., video, audio, images, PDFs, Word documents, Excel spreadsheets, PowerPoint presentations, etc.) by downloading the media to a client device 120 and viewing the media locally. The processing unit 260 may also include a communication module 278 that provides functionality for individual users and institutional users to communicate (similar to email and/or instant messaging).

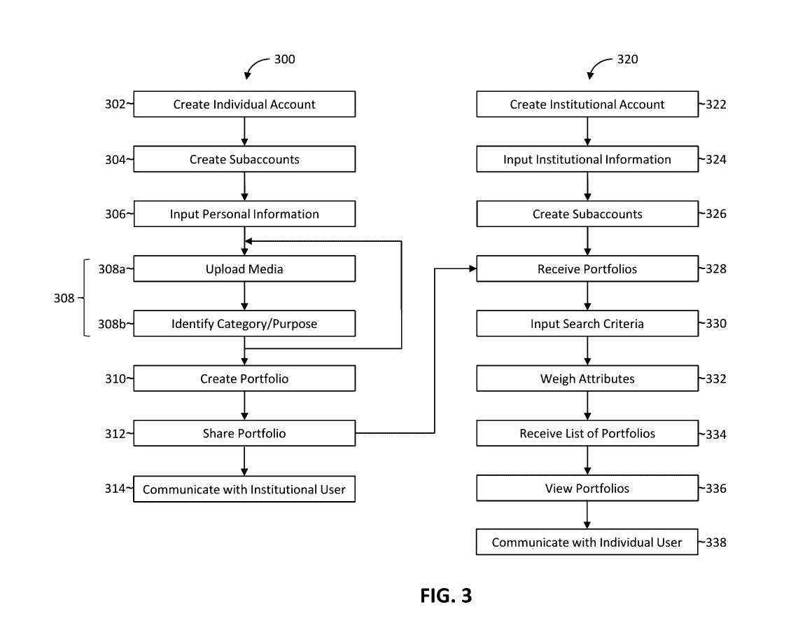

FIG. 3 is a flowchart illustrating a process 300 for individual user to create and share portfolios with institutional users and a process 320 for institutional users to receive and view those portfolios according to exemplary embodiments of the present invention.

As shown in FIG. 3, the individual user creates an individual account in step 302. One or more individual users may optionally create subaccounts in step 304. For example, a parent may create an individual account in step 302 and subaccounts in step 304 for children in the same household. Each of the remaining operations in process 300 may be performed by an individual user that has recited either an individual account or a subaccount.

The individual user inputs personal information 222 in step 306. The personal information 222 may include, for example, name, address, phone number, email address, social media user names (e.g., Facebook, Twitter, etc.), gender, etc. For individuals looking to apply to educational institutions, the system 200 may enable the individual to enter personal information 222 that includes, for example, attributes of his or her desired school such as single gender or co-ed, religious affiliation, urban or rural setting, target state, etc. For individuals looking to apply for employment, the system 200 may enable the individual to enter personal information 222 that includes, for example, attributes of his or her desired employers such as company size, target state, etc. For individuals looking to apply either to educational institutions or for employment, system 200 may also enable the individual to enter personal information 222 that includes his or her desired profession.

The individual user adds content 224 to digitally store examples of his or her best work, awards, etc., in step 308. As discussed in more detail below, each piece of content 224 is uploaded as evidence that the individual user possesses a certain attribute such as academics, performing arts, athletics, etc. To that end, each time the individual adds content 224, the individual may upload media in step 308a and identify a category for that content 224 (identifying the attribute) in step 308b.

The individual user creates a portfolio 226 in step 310 by selecting some or all of the content 224 uploaded in step 308. The individual user shares the portfolio 226 in step 312. The system 200 may publish the portfolio 226 on the internet, meaning anyone with a link to the portfolio 226 can view that portfolio 226 regardless of whether he or she is a registered user of the system 200. Accordingly, the individual user GUI 280 may provide functionality for the individual user to share the portfolio 226 in step 312 by creating a link to the portfolio 226. In another embodiment, individual user GUI 280 may provide functionality for the individual user to share the portfolio 226 with a specific institutional user in step 312 (for example, by searching for and selecting an institutional user such that the institutional user may view the portfolio 226 using the institutional user GUI 290 as discussed below). The system 200 may provide functionality for the individual user to communicate with the institutional user in step 314.

The process 320 enables an institutional user to search portfolios 226. An institutional user (referred to as an “Access User” in the Applicant's provisional patent application) may be, for example, an educational institution such as a college, university, high school, etc., an employer, an employment agency, etc. The institutional user creates an institutional account in step 322 and inputs institutional information 242 in step 324. The institutional information 242 may include, for example, details regarding the institution such as the name, address, industry, desired applicants, etc. Subaccounts may be created in step 326 to allow multiple employees of an institution to use the same institutional account.

The system 200 may provide functionality for an institutional user to search all portfolios 226 via the institutional user GUI 290. Additionally or alternatively, the system 200 may provide individual users with the functionality to share portfolios 226 with a particular institutional user via the individual user GUI 280 and functionality for the institutional user to search the portfolios shared with the institutional user via the institutional user GUI 290. In those embodiments, the portfolios 226 are shared with the institution by individual users in in step 328. The system 200 may also provide functionality for the institutional user to input search criteria 246 in step 330. As described in more detail below, the search criteria 246 allows the institutional user to view the shared portfolios 226 of individual users that have certain attributes desired by the institutional user. Further, the system 200 may also provide functionality for the institutional user to rank the shared portfolios 226 by weighing those attributes in step 334 (for example, using numerical weights from 1 to 9 where an attribute that is weighted a 9 is 9-times more important than an attribute that is weighted a 1).

The system 200 allows the institutional user to view the portfolios 226 (either a published, publically available portfolio 226 as described above, or a portfolio 226 shared with the institutional user as described above, or a portfolio that meets the search criteria 226 input in step 330) in step 336. The system 200 may provide functionality for the institutional user to communicate with the individual user in step 338. For example, the institutional user may communicate with the individual user to formally apply for a position at the institution.

When ranking the portfolios 226 of individual users, the system 200 may, for example, weight each portfolio 226 based on whether the portfolio 226 includes content in the categories (i.e., identifying the attributes) identified by the institutional user. For example, if the institutional user indicates that academics should be weighted as a 9 and sports should be weighted as a 2, then the system 200 would determine that an individual user with content categorized as academics and content categorized as sports should have a score of 11 for that particular institutional user (whereas then the system 200 would determine that an individual user with content categorized as academics without content categorized as sports should have a score of 9 for that particular institutional user).

In another embodiment, the system 200 may weight each portfolio 226 based on the number content items in the categories (i.e., identifying the attributes) identified by the institutional user. For example, if the institutional user indicates that academics should be weighted as a 9 and sports should be weighted as a 2, then the system 200 would determine that an individual user with two content items categorized as academics and no content items categorized as sports should have a score of 18 for that particular institutional user (whereas then the system 200 would determine that an individual user with two content items categorized as sports and no content items categorized as academics should have a score of 4 for that particular institutional user).

In another embodiment, the institutional user GUI 190 may provide functionality for the institutional user to view a portfolio 226 from an individual user and evaluate each individual user for the presence of each attribute (e.g., on a 1 to 5 scale). In this embodiment, the system 200 may multiple each user's attribute rating by the weight for that rating received from the institutional user. For example, if the institutional user indicates that academics should be weighted as a 9 and sports should be weighted as a 2, then the system 200 would give an individual user with a 5 rating for academics and a 0 rating for sports a score of 5×9=45 (whereas then the system 200 would determine that an individual user with a 4 rating for academics and a 5 rating for sports a score of (4×9)+(5×2)=46 for that particular institutional user).

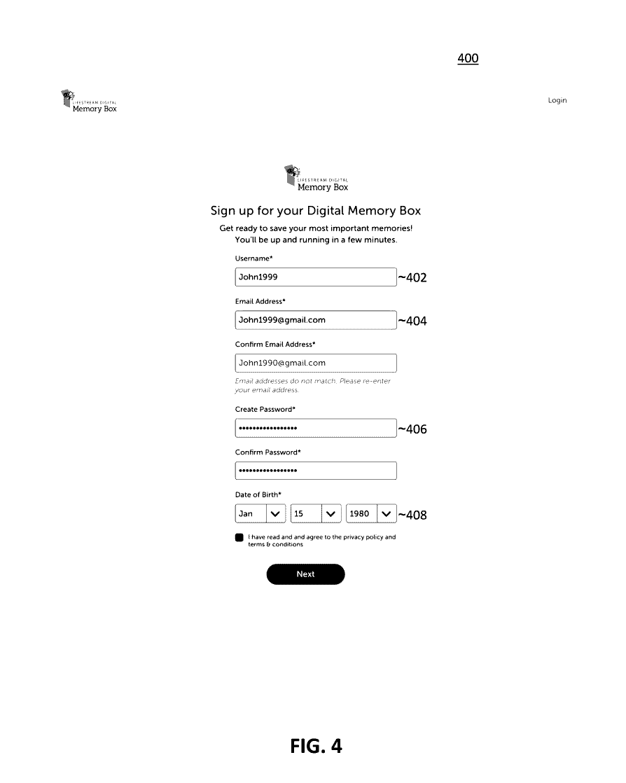

FIGS. 4-12 illustrate views 400-1200 of the individual user GUI 280 that provides functionality for individual users to digitally store examples of their best work, awards, etc., as well as create, manage, and share portfolios 226 according to exemplary embodiments of the present invention.

FIG. 4 illustrates an account creation view 400 of the individual user GUI 280 that provides functionality for an individual user to create an account. As shown in FIG. 4, the account creation view 400 provides functionality for the individual user to input a username 402, an email address 404, a password 406, and a date of birth 408.

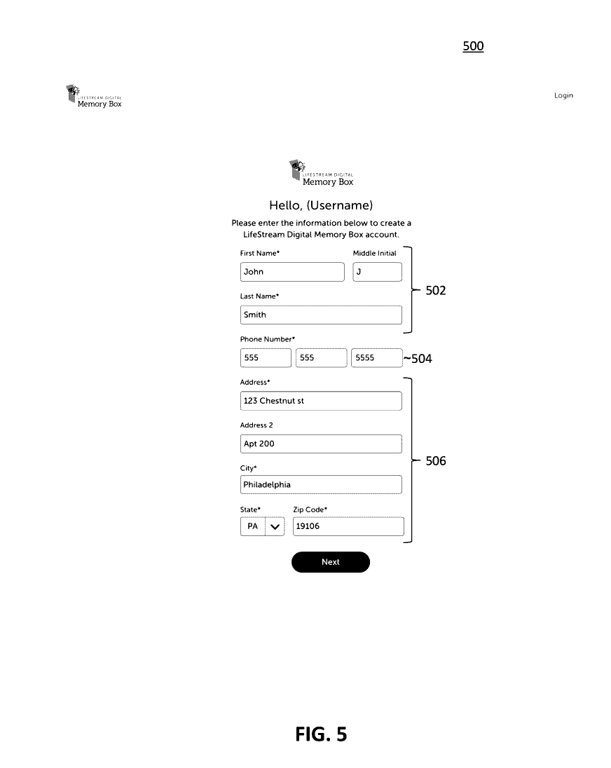

FIG. 5 illustrates a personal information view 500 of the individual user GUI 280 that provides functionality for an individual user to input personal information 222. As shown in FIG. 5, the personal information view 500 includes functionality for the individual user to input a name 502, a phone number 504, and an address 506.

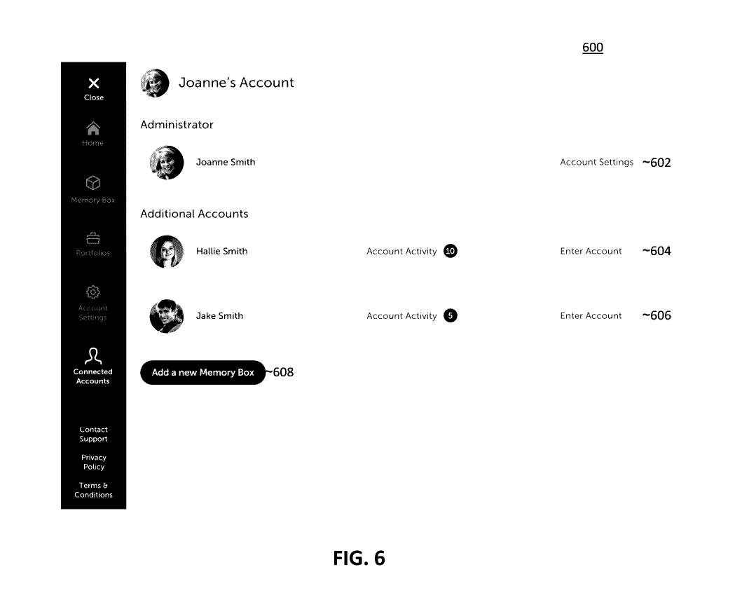

FIG. 6 illustrates a connected accounts view 600 of the individual user GUI 280 that provides functionality for an individual user to view and/or manage subaccounts. As shown in FIG. 6, an account 602 (for example, a parent's account) may include subaccounts 604 and 606 (for example, accounts for children in the same household). The connected accounts view 600 includes functionality 608 to add an additional subaccount.

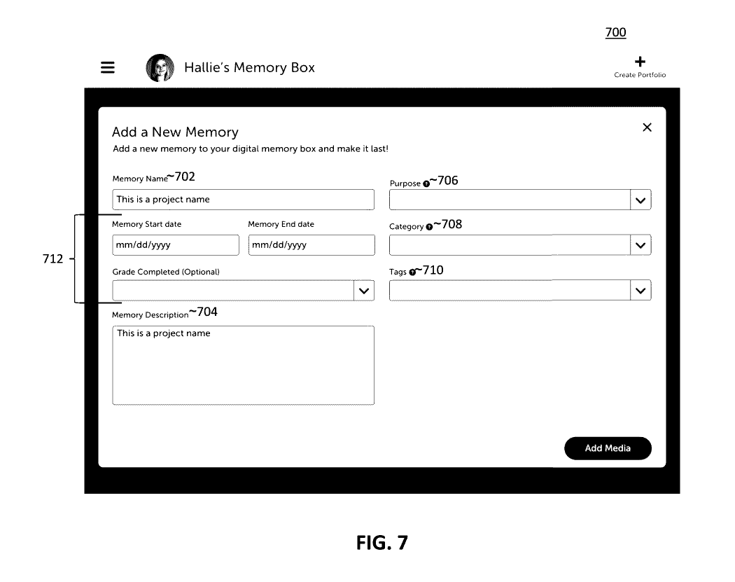

FIG. 7 illustrates an add content view 700 of the individual user GUI 280 that provides functionality for an individual user to add content 224 to highlight a particular attribute of the individual user (and an activity that the user has participated in). As shown in FIG. 7, the add content view 700 includes functionality to input a project (or memory) name 702, a project (or memory) description 704, a category 708 for that content, the purpose 706 for participating in the activity highlighted by the content, tag(s) 710 for that content, and a time period 712 that the individual user participated in that activity.

Instead of allowing the individual user to input any category 708, purpose 706, and/or tag 710, the system 200 may provide predetermined lists of categories 708, purposes 706, and/or tags 710 and provide functionality for the individual user to select only from those predetermined lists. For example, the list of categories 708 may include the categories 708 found in table 1 and the list of purposes 706 may include the purposes 706 found in table 2:

TABLE 1
Category

Academics
Extracurricular
Athletics
Interests/Hobbies
Community Involvement
Employment/Internship
The Arts
Special Memory
Professional Work
Life Skills

TABLE 2
Purpose

Award/Certificate
Grant
Scholarship
Championship
Finalist
Medal
Special Project
Event
Landmark/Milestone
Promotion

As shown in Table 3, the system 200 may store predetermined lists of tags 710, each associated with a different category 708 and provide functionality for an individual user to select a tag 710 from the list of tags 710 associated with the selected category 708. For example, if a user selects “academics” as category 708, the individual user GUI 280 may provide functionality for the individual user to select agriculture, anthropology, archaeology, etc., as the tag 710.

TABLE 3

| Academics | Extra Curricular | Athletics |
|---|---|---|
| Agriculture | Adult/Senior Organization | Alpine Skiing |
| Anthropology | Academic Club | Archery |
| Archaeology | Art Club | Auto Racing |
| Area-Studies | Athletic Club | Badminton |
| Automobile Repair | Athletics | Baseball |
| Biology | Band | Basketball |
| Business | Book Club | Bicycle |
| Chemistry | Career Club | Bowling |
| Communication Studies | Cheerleading | Boxing |
| Computer Aided Drafting | Chess Club | Cheerleading |
| Computer Science | Choir/Chorus | Cross Country |
| Cosmetology | Citizenship Club | Cross Country Skiing |
| Cultural-Ethnic Studies | Community Service/Social | Curling |
| | Service | |
| Earth Sciene | Cooking | Cycling |
| Economics | Boys/Teen Youth Organization | Dance |
| Education | Girls/Teen Youth Organization | Equestrian |
| Electrical | Dance | Fencing |
| Engineering | Debate Team | Field Hockey |
| Environmental Studies | Drama Club | Figure Skating |
| Ethnic Studies | Entrepreneurship | Fishing |
| Foreign Language | Fan Club | Football |
| Formal Science | Fencing | Golf |
| Gender-Sexuality Studies | Greek Life (Fraternity/Sorority) | Gymnastics |
| Geography | Horseback Riding | Ice Hockey |
| History | International Club | Lacrosse |
| Home Economics | Internship | Luge |
| Humanities | Journalism/School Paper | Martial Arts |
| Journalism/Publishing | Junior Achievement | Motorboat Racing |
| Junior Reserve Officers | Lego Club | Motorcycle Racing |
| Training Corps | | |
| Language Arts | Math Club | Paddle Sports |
| | | (Kayak, Canoeing, etc) |
| Law | Mock Trial Club | Raquetball |
| Library and Information | Model UN | Rifle |
| Services | | |
| Linguistics and Languages | Music Club | Rowing |
| Literature | National Honors Society | Rugby |
| Mathematics | National Jr. Honors Society | Sailing |
| Medicine and Health | Orchestra | Snowboard |
| Metal Working | Outdoor Club | Soccer |
| Military Science | Photography | Softball |
| Natural Science | Public Service | Speed Skating |
| Perfoming Arts | Public Speaking | Swimming & Diving |
| Philosophy | Faith Based Activity/Club | Syncronized Swimming |
| Physics | Robotics Club | Tennis |
| Political Science | Science Club | Track and Field |
| Psychology | Skateboarding Club | Volleyball |
| Psychology | Student Government | Water Polo |
| Public Administration | Study Abroad | Weightlifting |
| Religion | Surf Club | Wrestling |
| Social Sciences | Tutoring/Mentoring | |
| Social Studies | Writing Club | |
| Sociology | Yearbook | |
| Space Science | | |
| Sports Science | | |
| Systems Science | | |
| Visual Arts | | |
| Wood Working | | |

| Interests/Hobbies | Community Involvement | Employment/Internship |
|---|---|---|
| Arts & Crafts | Adult Education/Training | Attendance |
| Astrology | Alcohol & Drug Recovery Support | Budget Management |
| Biking | Animal Rights Support | Client/Customer Service |
| Bird Watching | Auxillary Police | Communications |
| Book Collection | Boys Youth Organization | Conflict Resolution |
| Camping | Career Assistance | Cost Saving Initiative |
| Card Collection | Child Health & Wellness | Detail Orientation |
| Chess | Community Child Care | Employee Recruitment |
| Child Care | Community Education | Event Coordination |
| | Support/Training | |
| Collecting (General) | Community Home Building/Re- | Exceed Goals |
| | building | |
| Community Service | Community Outreach | Fundraising |
| Cooking | Community Rights Activist | Increase Sales |
| Digital Arts | Community Social Initiatives | Leadership |
| Do It Yourself | Conservation Initiatives | Management of Staff |
| Fashion & Modeling | Developmental Disability Support | Orgainzational Structure |
| Gardening | Disaster Recovery | Presentation Skills |
| Geneology | Environmental Care/Green | Product Concept |
| | Initiatives | |
| Geocaching | Faith Based Initiatives | Product Development |
| Geology | Food Distribution/Hunger Support | Professional Development |
| Ghost Hunting | Fundraising/Charity Initiatives | Project Management |
| Glass Blowing | Girls Youth Orgnanization | Public Relations |
| Hiking/Backpacking | Healthcare Support | Quality Assurance |
| Horseback Riding | Historical Initiatives/Community | Strategic Planning |
| | History | |
| Lego Building | Homeless/Shelter Support | Team Building |
| Magic | Junior Achievement | Technical Merrit |
| MetalWorking | Leadership Support/Training | Time Management |
| Model Building | Literacy Support | Training of Others |
| Music | Military Support | |
| Origami | Senior Services | |
| Paintball | Sports Enrichment | |
| Painting | Technology Training & Leadership | |
| Pets/Animals | The Arts for the Community | |
| Photography | Veteran Support | |
| Quilting | Volunteer (General) | |
| Quilting/Sewing | Volunteer EMT Dept | |
| Roller Blading/Roller | Volunteer Fire Dept | |
| Skating | | |
| Running/Jogging | Youth Education/Training | |
| Sailing | Youth Mentoring Program | |
| Scouting | | |
| Scrapbooking | | |
| Scuba Diving | | |
| Sculpting | | |
| Sewing | | |
| Singing | | |
| Skating | | |
| Skydiving | | |
| Sports | | |
| Stamp Collection | | |
| Surfing | | |
| Taekwondo | | |
| Tai chi | | |
| Traveling | | |
| Vehicle Restoration | | |
| Video Gaming | | |
| Volunteering | | |
| Walking | | |
| Water Sports | | |
| Wine Tasting | | |
| Woodworking | | |
| Writing | | |
| Yoga | | |

| The Arts | Special Memory | Professional Work | Life Skills |
|---|---|---|---|
| Drawing | Just Something | Actor/Actress | Collaboration |
| | Special to Me | | |
| Painting | | Advertising/Marketing | Connecting |
| Ceramics | | Agricultutre | Courage |
| Photography | | Architecture/Design | Creating Solutions |
| Achitecture | | Artist | Creativity |
| Sculpture | | Astronomer | Critical Thinking |
| Music | | Author/Writer/Content | Curiosity |
| | | Specialist | |
| Theatre | | Baker | Empathy |
| Dance | | Blogger/Blog Monitor | Entrepreneurial |
| | | | Thinking |
| Graphic Arts | | Bricklayer | Initiative |
| Literary Arts | | Bus Driver | Inquiry |
| Arts Criticism | | Business | Networking |
| Culinary Arts | | Butcher | Participation |
| Fine Art | | Carpenter | Passion to Learn |
| | | Chef/Cook | Problem Solving |
| | | Cleaner | Real Work |
| | | Cultural | Resilience |
| | | Customer Service | Sharing |
| | | Data/Business Analyst | Synthesis |
| | | Database Administrator | Philanthropy |
| | | Dentist | Leadership |
| | | Designer | |
| | | Divinity | |
| | | Doctor | |
| | | Education/Academic | |
| | | Administration | |
| | | Electrician | |
| | | Engineering/Technology | |
| | | Environmental Studies | |
| | | Factory Worker | |
| | | Family Consumer | |
| | | Science | |
| | | Farmer | |
| | | Finance | |
| | | Fireman/Fire fighter | |
| | | Fisherman | |
| | | Florist | |
| | | Gardener | |
| | | Hairdresser | |
| | | Historian | |
| | | Information Systems | |
| | | Intelligence | |
| | | Journalism-Media- | |
| | | Communication | |
| | | Judge | |
| | | Law | |
| | | Lawyer | |
| | | Lecturer | |
| | | Librarian | |
| | | Library/Museum Studies | |
| | | Lifeguard | |
| | | Mathematician | |
| | | Mechanic | |
| | | Medical | |
| | | Military Sciences | |
| | | Model | |
| | | Network Architect | |
| | | Newsreader | |
| | | Nurse | |
| | | Optician | |
| | | Painter | |
| | | Pharmacist | |
| | | Photographer | |
| | | Pilot | |
| | | Plumber | |
| | | Policeman/Policewoman | |
| | | Politician | |
| | | Postman | |
| | | Programmer/Operator | |
| | | Public Administration | |
| | | Public Relations | |
| | | Public Service | |
| | | Real Estate Agent | |
| | | Receptionist | |
| | | Sales/Account | |
| | | Management | |
| | | Sanitation Worker | |
| | | Scientist | |
| | | Secretary/Assistant | |
| | | Social Media Specialist | |
| | | Social Work | |
| | | Software/Hardware | |
| | | Engineer | |
| | | Soldier | |
| | | Statistician | |
| | | System Administrator | |
| | | Systems Analyst | |
| | | Tailor | |
| | | Taxi driver | |
| | | Teacher | |
| | | Technology | |
| | | Repair/Machine Repair | |
| | | Technology Research | |
| | | Traffic Warden | |
| | | Translator | |
| | | Transportation | |
| | | Veterinary Doctor | |
| | | Waiter/Waitress | |
| | | Window cleaner | |

As discussed in more detail below, because each individual user selects from the same list of categories 708, purposes 706, and/or tags 710, institutional users are better able to compare individual users and identify individual users with particular attributes.

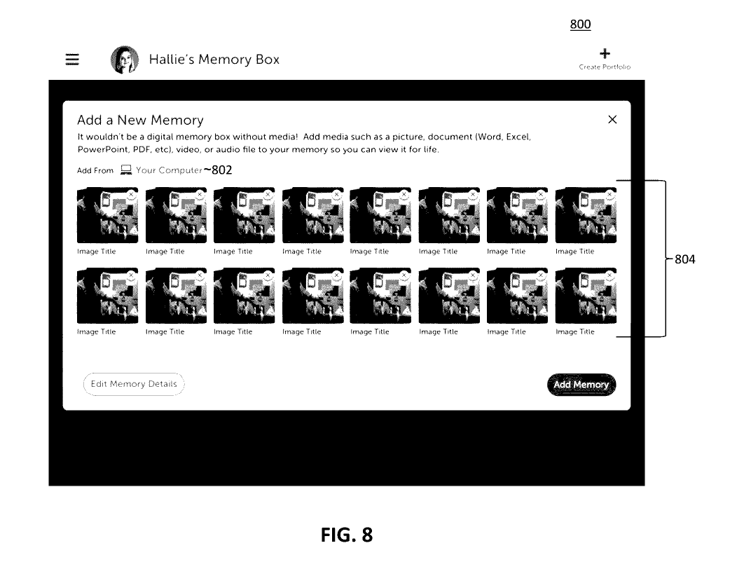

FIG. 8 illustrates an add media view 800 of the individual user GUI 280 that provides functionality for an individual user to include media in the content 224. As shown in FIG. 8, the add media view 800 includes functionality 802 to upload media from the individual user's remote device 120 or functionality 804 to select media that has already been uploaded. The media may include, for example, video files, audio files, images, PDF files, Word documents, Excel spreadsheets, PowerPoint presentations, etc.

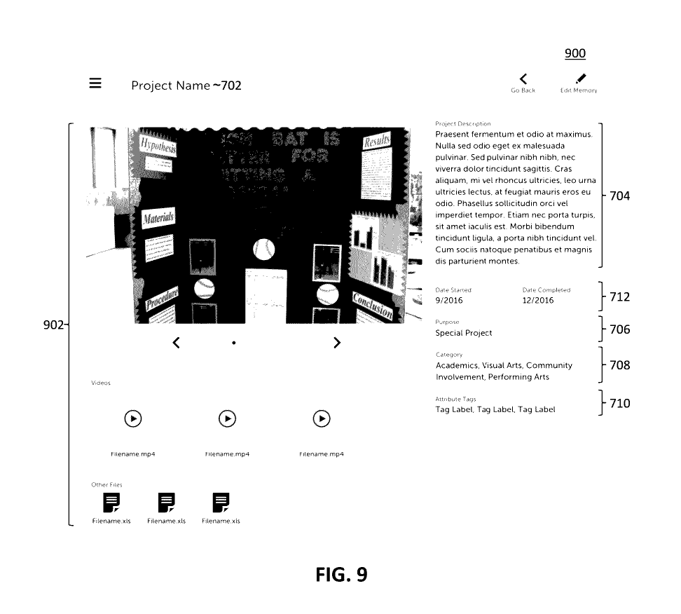

FIG. 9 illustrates a view content view 900 of the individual user GUI 280 that provides functionality for an individual user to view content item 224 uploaded via the individual user GUI 280. As shown in FIG. 9, the individual user may view media 902 (uploaded and/or selected using the add media view 800) as well as the project name 702, project description 704, purpose 706, category 708, tags 710, and time period 712 included in a content item 224.

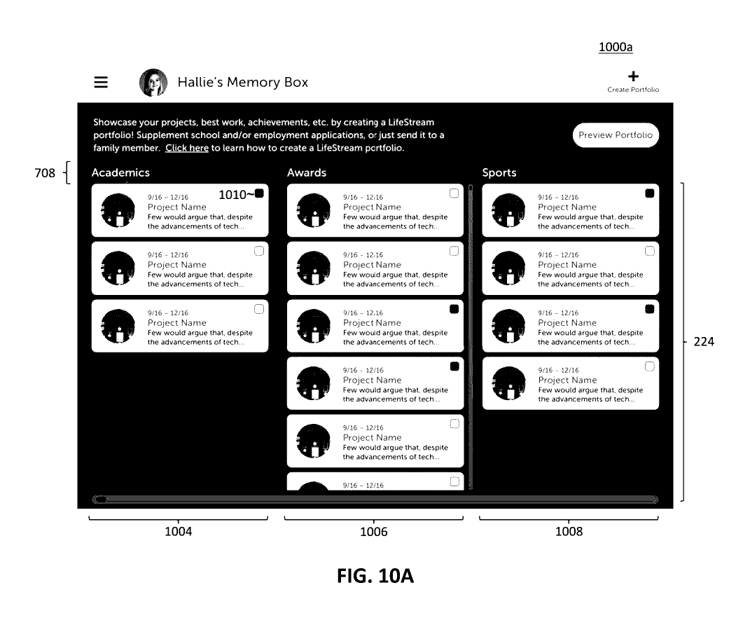

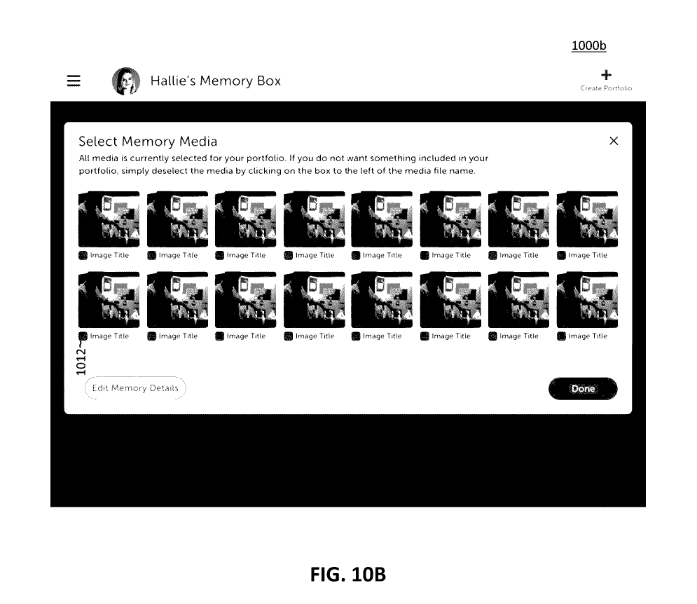

FIGS. 10A and 10B illustrates create portfolio views 1000a and 1000b of the individual user GUI 280 that provides functionality for an individual user to select content 224 and create a portfolio 226. As shown in FIG. 10, the create portfolio view 1000 includes content 224 (uploaded by the individual user via the add content view 700 and the add media view 800), which is separated into categories 708 (e.g., academics 1004, awards 1006, sports 1008, etc.). The create portfolio view 1000a provides functionality for individual users to select content 244, including all media for that particular content item (i.e., project), for example, using check boxes 1010. Additionally or alternatively, the individual user GUI 280 provides functionality for an individual user to individual select media from a content item 224 (i.e., project) by selecting the content item 224 using the create portfolio view 1000a as shown in FIG. 10A and individual selecting media from that content item using the create portfolio view 1000b as shown in FIG. 10B, for example, using check boxes 1012.

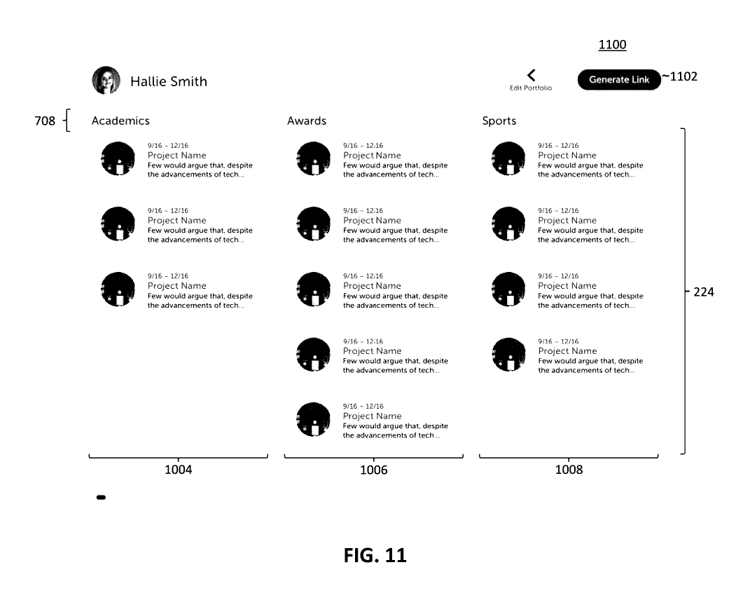

FIG. 11 illustrates a generate link view 1100 of the individual user GUI 280 that provides functionality for an individual user to generate a link to a portfolio 226. As shown in FIG. 11, a portfolio 226 may include content 224 separated into categories 708 (e.g., academics 1004, awards 1006, sports 1008, etc.). The share portfolio view 1100 provides functionality 1102 for individual users to generating a link to a particular portfolio.

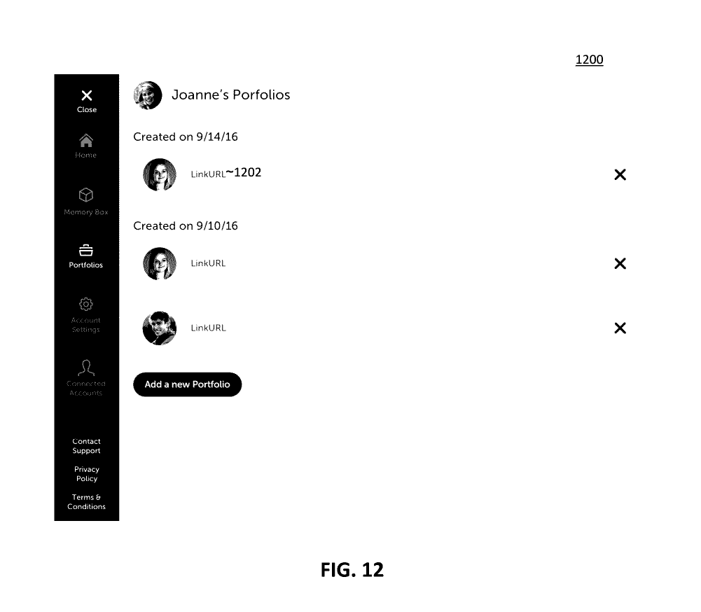

FIG. 12 illustrates a view portfolios view 1200 of the individual user GUI 280 that provides functionality for an individual user to view a list of portfolios 226 created by the individual user. As shown in FIG. 12, an individual user may view a list of portfolios 226 created by the individual user and a link 1202 to each of those portfolios 226. If the individual user has subaccounts, the system 200 may provide functionality for the primary account holder (e.g., a parent) to view all portfolios 226 created by subaccount holders (e.g., children).

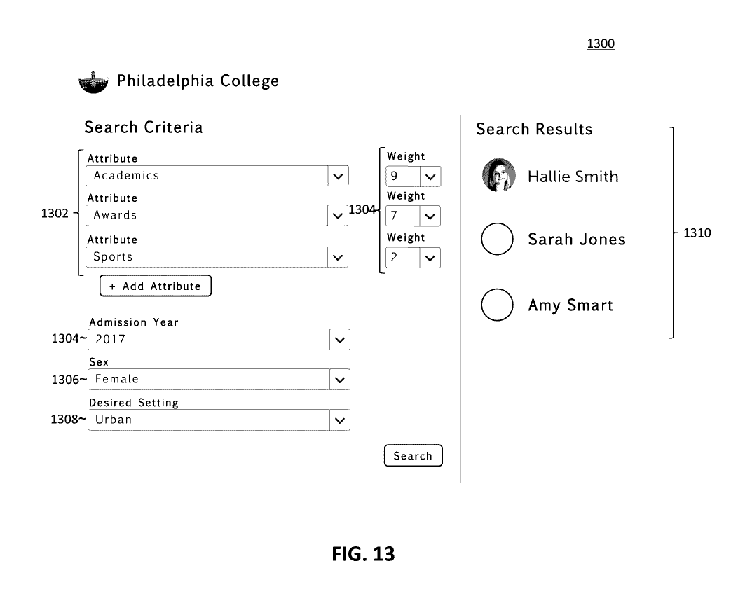

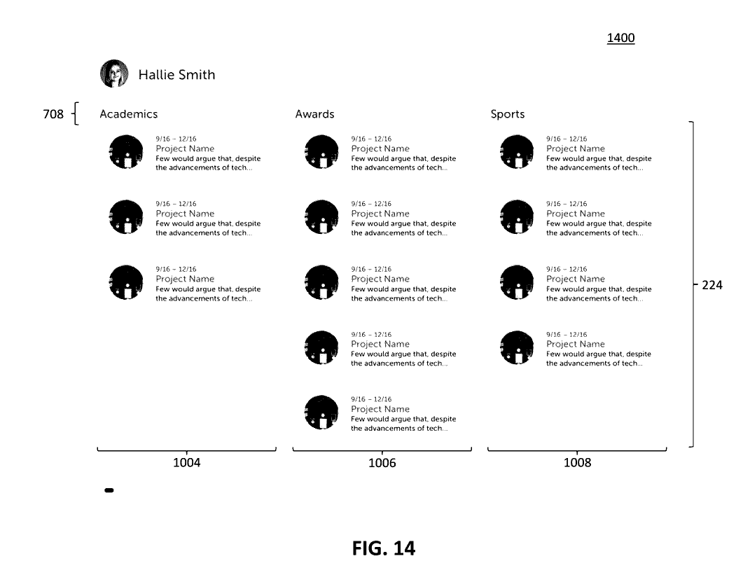

FIGS. 13-14 illustrate views of the institutional user GUI 290 that provides functionality for institutional users to search for and view portfolios 226 shared by individual users according to exemplary embodiments of the present invention.

FIG. 13 illustrates a portfolio search view 1300 of the institutional user GUI 290 that provides functionality for an institutional user to search the portfolios 226 shared with the institutional user by individual users. As shown in FIG. 13, an institutional user may search the portfolios shared with the institutional user by identifying attributes 1302 (e.g., academics, awards, sports, etc.) of the individual user. (As described above, the system 200 may provide functionality for an individual user to identify a particular attribute by uploading content 244 and identifying the particular attribute by selecting that attribute as the category 708 for that content.) The institutional user may also specify personal information 222, such as admission year 1304, sex 1306, desired setting 1308, etc. The system 200 may also provide functionality for the institutional user to rank each of the portfolios 226 by inputting weights 1304 for each of the each of the attributes 1302 (for example, a number from 1 to 9 indicate the importance of that particular attribute). The portfolio search view 1300 outputs a list 1310 of portfolios 226 shared with the institutional user that meet the search criteria input by the institutional user.

In addition to providing functionality for an institutional user to search for an attribute 1302 by selecting a category 708, the institutional user GUI 290 may provide functionality for the institutional user to further refine his or her search by identifying a purpose 704. For example, the institutional user may input not only a category 708 (e.g., “academics”) but also a purpose (e.g., “scholarship”) to identify, for example, individual users with a portfolio 226 that indicates that the individual user has received a scholarship for his or her academics. Additionally, the institutional user GUI 290 may provide functionality for the institutional user to further refine his or her search by identifying a tag 710. For example, the institutional user may input a tag 710 (e.g., “ceramics”) to identify, for example, individual users with a portfolio 226 that indicates that the individual user has an interest in ceramics.

FIG. 14 illustrates a view portfolio view 1400 of the institutional user GUI 290 that provides functionality for an institutional user to view a portfolio 226 shared with the institutional user. As shown in FIG. 14, includes content 224, which is separated into categories 708 that correspond to attributes of the individual user (e.g., academics 1004, awards 1006, sports 1008, etc.). By selecting content 224, the institutional user can view the content 244 (as shown, for example, in the view content view 900 of the individual user GUI 280 illustrated in FIG. 9).

By providing an easy-to-use interface for digitally storing evidence of users' best work, awards, etc. and for creating, sharing, and managing portfolios, the individual user GUI 180 allows individual users to quickly and easily highlight their accomplishments and allows institutional users to easily and accurately learn about and compare individual users. By ensuring that all individual users use the same nomenclature to refer to the same attributes, the individual user GUI allows an institutional user to more accurately compare individual users and determine which have shared content as evidence that they possess each attribute.

While preferred embodiments have been set forth above, those skilled in the art who have reviewed the present disclosure will readily appreciate that other embodiments can be realized within the scope of the invention. For example, disclosures of specific numbers of hardware components, software modules and the like are illustrative rather than limiting. Therefore, the present invention should be construed as limited only by the appended claims.

What is claimed is:

1. An individual user graphical user interface (GUI) that provides functionality for an individual user to:
upload a plurality of content items;
identify a category for each of the plurality of content items, each of the categories identifying to an attribute of the individual user;
create a portfolio by selecting one or more of the content items; and
share the portfolio such that the portfolio may be viewed remotely via a communications network.

2. The individual user GUI of claim 1, wherein:
the individual user GUI includes a predetermined list of categories; and
the individual user GUI provides functionality identify a category for each of the plurality of content items by selecting a category from the predetermined list of categories.

3. The individual user GUI of claim 1, wherein the individual user GUI provides functionality for the individual user to include media with each of the plurality of content items.

4. The individual user GUI of claim 1, wherein the individual user GUI provides functionality for the individual user to include one or more video files, audio files, images, portable document format (PDF) documents, Word documents, Excel spreadsheets, or PowerPoint presentations with each of the plurality of content items.

5. The individual user GUI of claim 1, further comprising an institutional user GUI that provides functionality for an institutional user to:
identify one or more attributes; and
search for portfolios that include content items in the categories identifying the one or more attributes identified by the institutional user.

6. The individual user GUI of claim 5, wherein the institutional user GUI further provides functionality for the institutional user to:
rank the portfolios shared with the institutional user based on whether the portfolios include content items in the categories identifying the one or more attributes identified by the institutional user.

7. The individual user GUI of claim 5, wherein the institutional user GUI provides functionality for the institutional user to:
identify a plurality of attributes:
identify a weight for each of the plurality of attributes identified by the institutional user;
rank the portfolios shared with the institutional user by:
for each portfolio, determining a score by adding the weight identified by the institutional user for each attribute where the portfolio includes at least one content item in the category identifying that attribute.

8. The individual user GUI of claim 1, wherein the institutional user GUI further provides functionality for an institutional user to communicate with the individual user.

9. A method, comprising:
providing an individual user graphical user interface (GUI) that provides functionality for an individual user to:
upload a plurality of content items;
identify a category for each of the plurality of content items, each of the categories identifying to an attribute of the individual user;
create a portfolio by selecting one or more of the content items; and
share the portfolio with an institutional user such that the portfolio may be viewed remotely via a communications network.

10. The method of claim 9, wherein:
the individual user GUI includes a predetermined list of categories; and
the individual user GUI provides functionality identify a category for each of the plurality of content items by selecting a category from the predetermined list of categories.

11. The method of claim 9, wherein the individual user GUI provides functionality for the individual user to include media with each of the plurality of content items.

12. The method of claim 9, further comprising:
providing an institutional user GUI that provides functionality for an institutional user to:
identify one or more attributes; and
search for portfolios shared with the institutional user that include content items in the categories identifying the one or more attributes identified by the institutional user.

13. The method of claim 12, wherein the institutional user GUI further provides functionality for the institutional user to:
rank the portfolios shared with the institutional user based on whether the portfolios include content items in the categories identifying the one or more attributes identified by the institutional user.

14. The method of claim 12, wherein the institutional user GUI provides functionality for the institutional user to:
identify a plurality of attributes:
identify a weight for each of the plurality of attributes identified by the institutional user;
rank the portfolios shared with the institutional user by:
for each portfolio, determining a score by adding the weight identified by the institutional user for each attribute where the portfolio includes at least one content item in the category identifying that attribute.

15. A non-transitory computer readable storage medium (CRSM) storing instructions that, when executed by a processor, cause a computer to:
provide an individual user graphical user interface (GUI) that provides functionality for an individual user to:
upload a plurality of content items;
identify a category for each of the plurality of content items, each of the categories identifying to an attribute of the individual user;
create a portfolio by selecting one or more of the content items; and
share the portfolio such that the portfolio may be viewed remotely via a communications network.

16. The CRSM of claim 15, wherein:
the individual user GUI includes a predetermined list of categories; and
the individual user GUI provides functionality identify a category for each of the plurality of content items by selecting a category from the predetermined list of categories.

17. The CRSM of claim 15, wherein the individual user GUI provides functionality for the individual user to include media with each of the plurality of content items.

18. The CRSM of claim 15, wherein the instructions further cause the computer to:
provide an institutional user GUI that provides functionality for an institutional user to:
identify one or more attributes; and
search for portfolios shared with the institutional user that include content items in the categories identifying the one or more attributes identified by the institutional user.

19. The CRSM of claim 18, wherein the institutional user GUI further provides functionality for the institutional user to:
rank the portfolios shared with the institutional user based on whether the portfolios include content items in the categories identifying the one or more attributes identified by the institutional user.

20. The CRSM of claim 15, wherein the institutional user GUI provides functionality for the institutional user to:
identify a plurality of attributes:
identify a weight for each of the plurality of attributes identified by the institutional user;
rank the portfolios shared with the institutional user by:
for each portfolio, determining a score by adding the weight identified by the institutional user for each attribute where the portfolio includes at least one content item in the category identifying that attribute.
